(19) United States
(12) Patent Application Publication
(10) Pub. No.: US 2007/0222365 A1
(43) Pub. Date: Sep. 27, 2007

(54) Light-Emitting Diode and Method of Manufacturing the Same

(76) Inventor: Hideo Tamamura, Chiba-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 11/587,969

(22) PCT Filed: May 16, 2005
(86) PCT No.: PCT/JP05/09287

§ 371 Date: Oct. 27, 2006

Related U.S. Application Data
(60) Provisional application No. 60/584,138, filed on Jul. 1, 2004.

(30) Foreign Application Priority Data
May 18, 2004 (JP) 2004-147539
May 18, 2004 (JP) 2004-147542
May 18, 2004 (JP) 2004-147540
May 18, 2004 (JP) 2004-147541

(51) Int. Cl. H01J 1/62; H01J 9/00

(52) U.S. Cl. 313/498; 445/1

(57) ABSTRACT

The present invention provides a low-cost light-emitting diode having little irregular color. A light-emitting diode converts light of a first light emission wavelength emitted from an LED as a primary light emission source into light of a second light emission wavelength, using one or a few kinds of phosphor materials. A thin film mainly made of a phosphor material is applied to a light extracting surface of the LED as the primary light emission source, thereby converting a wavelength and emitting light of the secondary light emission wavelength.

### CROSS REFERENCE TO RELATED APPLICATION

This application is an application filed under 35 U.S.C. §111(a) claiming benefit pursuant to 35 U.S.C. §119(e) (1) of the filing date of the Provisional Application No. 60/584,138 filed on Jul. 1, 2004, pursuant to 35 U.S.C. §111(b).

### TECHNICAL FIELD

The present invention relates to a light-emitting diode that is used for a light-emitting diode (LED) display, a backlight light source, a traffic light, and various kinds of indicators. Particularly, the invention relates to a light-emitting diode having a photoluminescence phosphor that converts light having a primary light emission wavelength generated from an LED as a primary light emission source into light having a secondary light emission wavelength, and emits this light.

### BACKGROUND ART

A light-emitting diode (LED) is used for various purposes taking advantage of its characteristics of compactness energy saving, and a long life.

This is because it is possible to obtain a light-emitting diode of an optional color tone by converting light having a light emission wavelength from the LED as a primary light emission source into light of a secondary light emission wavelength, using one or plural kinds of phosphor materials.

In other words, the light emission wavelength of light from the LED as the primary light emission source can be converted into light of a secondary light emission wavelength having a few kinds of wavelengths, using one or more kinds of phosphor materials, thereby obtaining light of an optional color tone. Therefore, a stable light emission can be obtained at low cost, and this can be used for the above various purposes.

A representative example of a method of mounting a phosphor of this light-emitting diode is described in Japanese Patent Application Unexamined Publication No. 7-99345, for example. This invention provides a light-emitting diode having the whole light-emitting element sealed with a resin comprising a light emitting chips positioned on the bottom surface of a cup. This resin includes a first resin that fills the inside of the cup, and a second resin that surrounds the first resin. The first resin contains a phosphor substance that converts a wavelength or a filter substance that absorbs a part of the light.

However, in general, the method of mixing a phosphor into a translucent resin in a liquid state at a normal temperature and thereafter thermally curing the mixture, thereby converting a wavelength, has the following problems.

1) The specific gravity of the resin and that of the phosphor are different. Therefore, when the phosphor is mixed into the liquid resin, the phosphor is precipitated before the mixture is thermally cured, due to the difference between the specific gravities of the liquid resin and the phosphor. Consequently, it becomes difficult to maintain a uniform mixed state until when the mixture is thermally cured. As a result, uniform color tone of the light-emitting diode is aggravated.

2) Generally, one or more different kinds of phosphors are used to improve the color tone of the light-emitting diode. In this case, specific gravities of the few kinds of phosphors are different, and this causes different precipitation speeds of the phosphors. Because of the different precipitation speeds, it becomes more difficult to obtain a uniform mixture of the phosphors with the resin, a uniform dispersion state, or a uniform precipitation speed. Consequently, it becomes more difficult to maintain a uniform mixed state until when the mixture is thermally cured. As a result, uniform color tone of the light-emitting diode is more aggravated.

3) In general, a light emission wavelength of light emitted from the LED as the primary light emission source is shorter than a secondary light emission wavelength of light obtained by converting the wavelength with a phosphor. Further, when a generally-used translucent resin absorbs light of a short wavelength, the translucence is degraded. The light emission wavelength of light from the LED as the primary light emission source is shorter than the secondary light emission wavelength of light obtained by wavelength conversion with the phosphor. Therefore, the light of the short primary light emission wavelength from the LED is partly transmitted through the translucent resin, in a state that the phosphor is mixed with the translucent resin. Consequently, it becomes hard to prevent the translucent resin from being degraded.

4) During a mixing of the resin with the phosphor, or during a sealing of an LED chip with a material obtained by mixing the resin with the phosphor, air is easily mixed into the mixture of these materials. This aggravates productivity. An expensive device is necessary to prevent this mixture of air. The provision of this device increases manufacturing cost.

In Japanese Patent Application Unexamined Publication No. 2-91980, it is proposed to add a phosphor layer having a limited particle size to a junction surface of a BN crystal layer of the LED. However, this proposal is different from the present invention that mainly relates to a GaN-system semiconductor. According to the present invention, white color of satisfactory color rendering properties is obtained by using one or a few kinds of phosphors. Further, the present invention proposes a detailed method of covering a main part of a light extracting surface.

The present invention solves the above conventional problems, and provides a light-emitting diode capable of obtaining a color tone at low cost while solving irregular color, and a method of manufacturing this light-emitting diode.

### DISCLOSURE OF THE INVENTION

In order to solve the above problems, the inventor of the present invention devoted attention to investigations, and has completed the present invention. The present invention relates to the following.

(1) A light-emitting diode comprising a GaN system LED (light-emitting diode) that emits light of a first light emission wavelength, and a phosphor material thin film that contains one or a few kinds of phosphor materials and converts light of the first light emission wavelength emitted from the LED into light of a second light emission wavelength, wherein the LED has a light extracting surface, and the phosphor material thin film is mainly made of a phosphor material.

(2) The light-emitting diode as described in (1) above, wherein the first light emission wavelength is shorter than the second light emission wavelength.

(3) The light-emitting diode as described in (1) or (2) above, wherein the LED is formed on a sapphire substrate or an SiC substrate.

(4) The light-emitting diode as described in any one of (1) to (3) above, wherein a light emission color of the light-emitting diode is a white color.

(5) The light-emitting diode as described in any one of (1) to (4) above, wherein the phosphor material thin film takes a 70% or more area of the light emission extracting surface of the LED.

(6) The light-emitting diode as described in any one of (1) to (5) above, wherein the phosphor material thin film takes an 80% or more area of the light emission extracting surface of the LED.

(7) The light-emitting diode as described in any one of (1) to (6) above, wherein the phosphor material thin film takes a 90% or more area of the light emission extracting surface of the LED.

(8) The light-emitting diode as described in any one of (1) to (7) above, wherein the phosphor material thin film takes a 95% or more area of the light emission extracting surface of the LED.

(9) The light-emitting diode as described in any one of (1) to (8) above, wherein the phosphor material thin film has a film thickness of 100 microns or less.

(10) The light-emitting diode as described in any one of (1) to (9) above, wherein the phosphor material thin film has a film thickness of 50 microns or less.

(11) The light-emitting diode as described in any one of (1) to (10) above, wherein the phosphor material thin film has a film thickness of 25 microns or less.

(12) The light-emitting diode as described in any one of (1) to (11) above, wherein a weight percentage of the phosphor in the phosphor material thin film is 70% or more.

(13) The light-emitting diode as described in any one of (1) to (12) above, wherein a weight percentage of the phosphor in the phosphor material thin film is 85% or more.

(14) A method of manufacturing a light-emitting diode comprising a GaN system LED (light-emitting diode) that emits light of a first light emission wavelength, and a phosphor material thin film that contains a phosphor material and converts light of the first light emission wavelength emitted from the LED into light of a second light emission wavelength, the method comprising a step of forming the thin-film layer containing the phosphor material on a light extracting surface of the LED.

(15) The method of manufacturing a light-emitting diode as described in (14) above, wherein the thin-film layer contains a plurality of phosphor materials.

(16) The method of manufacturing a light-emitting diode as described in (14) or (15) above, the method comprising a step of forming a thin film mainly made of a phosphor material on the light extracting surface of the LED in a state of an LED wafer or aggregated chips.

(17) The method of manufacturing a light-emitting diode as described in (14) or (15) above, the method comprising:

a step of forming a thin film mainly made of a phosphor material on the light extracting surfaces of a plurality of LEDs in a state of an LED wafer or aggregated chips; and

a step of preventing interference of a conduction at an electrode part due to insulation of the phosphor thin-film layer, by masking or etching a part of the phosphor thin-film layer or by combining masking and etching.

(18) The method of manufacturing a light-emitting diode as described in any one of (14) to (17) above, wherein in forming a thin film mainly made of a phosphor material on the light extracting surface of the LED, the phosphor thin film is formed on a side surface of LED chips in a state that two or more LED chips are aggregated.

(19) The method of manufacturing a light-emitting diode as described in any one of (14) to (18) above, wherein a weight percentage of the phosphor in the phosphor material thin film is 70% or more.

(20) The method of manufacturing a light-emitting diode as described in any one of (14) to (19) above, wherein a weight percentage of the phosphor in the phosphor material thin film is 85% or more.

Based on the present invention, it is possible to provide a light-emitting diode at low cost without irregular color.

### BRIEF DESCRIPTION OF THE DRAWINGS

FIGS. 1A to 1F are cross-sectional diagrams showing a representative method of manufacturing a light-emitting diode.

FIG. 2 is a cross-sectional diagram of an LED of a GaN system having a sapphire substrate, where a phosphor thin film is applied to the sapphire surface of the LED having electrodes on the same surface and to a light-emitting surface of a side surface.

FIG. 3 is a cross-sectional diagram of an LED of a GaN system having a sapphire substrate according to Example 2, where a phosphor thin film is applied to an electrode extracting surface in addition to the sapphire surface of the LED having electrodes on the same surface and to a light-emitting surface of a side surface.

FIG. 4 is a cross-sectional diagram of an LED of a GaN system having an SiC substrate according to Example 3, where a phosphor thin film is applied to the LED having electrodes on the upper surface and the lower surface.

FIG. 5 is a cross-sectional diagram of an LED of a GaN system having a sapphire substrate according to Examples 4 and 5, where a phosphor film is applied to a sapphire wafer at the time of manufacturing the LED.

FIG. 6 is a cross-sectional diagram of an LED of a GaN system having an SiC substrate according to Example 6, where a phosphor film is applied to an SiC wafer at the time of manufacturing the LED.

FIGS. 7A to 7C and FIGS. 7C to 7F are cross-sectional diagrams each showing a process of forming a phosphor film on an electrode extracting surface excluding an electrode part; FIG. 7C is a cross-sectional diagram of a flip-chip type LED of a GaN system according to Examples 7 and 8, where a phosphor film is applied to a sapphire wafer surface and the electrode extracting surface at the time of manufacturing the LED.

FIG. 8 is a cross-sectional diagram of a face-up type LED of an SiC system according to Examples 9 and 10, where a phosphor film is applied to an SiC wafer surface and an electrode extracting surface.

FIG. 9 is a cross-sectional diagram of an LED of a GaN system having electrodes formed on the same surface according to Example 11, where a phosphor layer is applied to the upper surface and the lower surface of an LED chip, and no phosphor layer is applied to a side surface.

FIG. 10 is a cross-sectional diagram of LEDs having the LED chips shown in FIG. 9 superimposed in a square pole shape, where one surface of the LED chips is aligned, and a phosphor layer is applied to this surface.

FIG. 11 is a cross-sectional diagram of an LED having the operation shown in FIG. 10 carried out repeatedly by four times, where a phosphor thin-film layer is applied to the four side surfaces of the LED chips.

FIG. 12 is a cross-sectional diagram of an LED having electrodes formed on SiC or different surfaces of an SiC substrate according to Example 12, where a phosphor layer is applied to an electrode extracting surface of a wafer substrate surface and an epitaxial surface, and no phosphor layer is applied to a side surface.

FIG. 13 is a cross-sectional diagram of an LED having the operation shown in FIG. 10 carried out repeatedly by four times, where a phosphor thin-film layer is applied to the four side surfaces of the LED chips.

### BEST MODE FOR CARRYING OUT THE INVENTION

An LED that is used for a light-emitting diode according to the present invention is a GaN-system LED, for example, AlGaInN-system LED. The GaN-system LED may have a high emission intensity and a stable light emission life, unlike the BN-system LED.

Further, in the present invention, it is possible to use, for example, a YAG-system material, although not particularly limited, as a phosphor that is used to convert light of a first light emission wavelength generated from the GaN-system LED into light of a second light emission wavelength. The present invention particularly concerns a light-emitting diode in which the GaN-system LED emits a blue color and the phosphor layer converts the color of this light into a white color.

According to the conventional technique, the above problems occur due to the mixing of a phosphor material into a resin. Therefore, these problems can be solved when a thin film of a phosphor material is directly applied to the light emitting surface of the LED chip as a primary light emission source, without using a resin on the light emitting surface.

A thin film can be formed by coating, printing, evaporating, sputtering, or by selecting other suitable method. It is a matter of course that a phosphor material is prepared in a state that various additives can be easily added to the phosphor material, with a view to directly applying the thin film to the LED.

Based on this, the above problems can be solved as follows.

(1) Even when the specific gravity of a resin is different from that of a phosphor, there is no process of mixing the phosphor with the resin.

Therefore, there is no problem of a precipitation due to a difference between the specific gravities of the resin and the phosphor. Accordingly, a uniform secondary light emission wavelength is obtained by passing the light of the LED as the primary light emission source through the thin film of the phosphor applied to the light emitting surface of the LED. As a result, the color tone of light obtained from the light-emitting diode becomes uniform.

(2) Because there is no process of mixing a resin with a phosphor that is obtained by mixing a few kinds of phosphors, there is no influence due to a difference between specific gravities of the few kinds of phosphors. As a result, the color tone of light obtained from the light-emitting diode becomes uniform, even when the few kinds of phosphors are mixed.

(3) Because a phosphor thin film is directly applied to the light emitting surface of the LED as the primary light emission source, the light of the LED having the short primary light emission wavelength is not transmitted through the translucent resin. As a result, the translucent resin is not degraded.

(4) Because there is no process of mixing the resin with the phosphor, air is not mixed into the phosphor. Therefore, productivity is improved, and an expensive device to prevent the mixing of air becomes unnecessary. As a result, manufacturing cost decreases.

Therefore, according to the present invention, a light-emitting diode having no irregular color can be provided at low cost.

In the light-emitting diode according to the present invention, it is preferable that the phosphor material thin film takes a 70% or more area of the light emission extracting surface of the LED. When the phosphor material thin film takes a small share of the light emission extracting surface of the LED, the efficiency of converting the wavelength of the primary light emission from the LED becomes low, and this is not preferable. It is more preferable that the phosphor material thin film takes an 80% or more area of the light emission extracting surface of the LED, more preferably a 90% or more area, particularly a 95% or more area.

In the light-emitting diode according to the present invention, it is preferable that the phosphor material thin film has a film thickness of 100 microns or less. When the phosphor material thin film has a larger film thickness, the efficiency of extracting light decreases.

More preferably, the film thickness is 50 microns or less, and most preferably, 25 microns or less.

In the light-emitting diode according to the present invention, the phosphor material thin film is mainly made of a phosphor material, and a weight percentage of the phosphor in the thin film is preferably 70% or more. When the weight percentage of the phosphor in the thin film is high, a uniform phosphor material thin film can be obtained, and a light-emitting diode having no irregular color can be obtained. More preferably, the weight percentage of the phosphor in the thin film is 85% or more.

The present invention provides a method of manufacturing a light-emitting diode having a GaN-system LED that emits light of a first light emission wavelength and a phosphor material thin film that contains a phosphor material and converts the light of the first light emission wavelength emitted from the LED into light of a second light emission wavelength. This method further includes a process of forming a thin film layer containing a phosphor material, on the light extracting surface of the LED.

Methods of coating, printing, evaporating, and sputtering a thin film layer containing a phosphor material, and a method of forming other thin film are explained below.

In order to coat a phosphor material, brushing and spraying, for example, may be used.

In order to print a phosphor material, screen printing, for example, may be used.

In order to sputter a phosphor material, DC sputtering, RF sputtering and MW sputtering, for example, using a target of a phosphor material may be used.

Other methods of forming a thin film containing a phosphor material include evaporation.

Because LED chips are very small and are mass produced, efficient production method is required.

In order to solve the above problems, the present invention proposes a method of manufacturing a light-emitting diode that has a GaN-system LED (a primary light emission source) which emits light of a first light emission wavelength, and a phosphor material thin film (a light emitting part of a secondary light emission wavelength) which contains a phosphor material and converts light of the first light emission wavelength emitted from the LED into light of the second light emission wavelength. According to this method, a thin film mainly made of a phosphor material is formed on a light extracting surface of the LED in a state of an LED wafer or aggregated chips.

A provision of the phosphor thin film in a state that LED chips are individually disconnected requires various kinds of devices in the formation process, which becomes expensive. Therefore, the phosphor thin film for wavelength conversion is manufactured in a state of an LED wafer (a wafer that forms the LED, or in a state of aggregated chips (an aggregate of LED chips). Preferably, this phosphor thin film is manufactured in the state of an LED wafer.

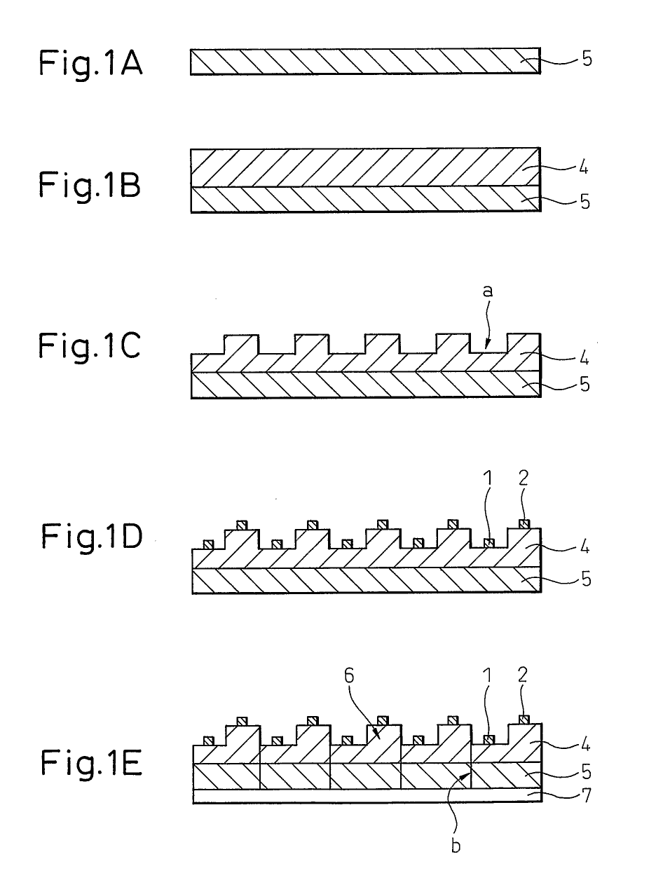

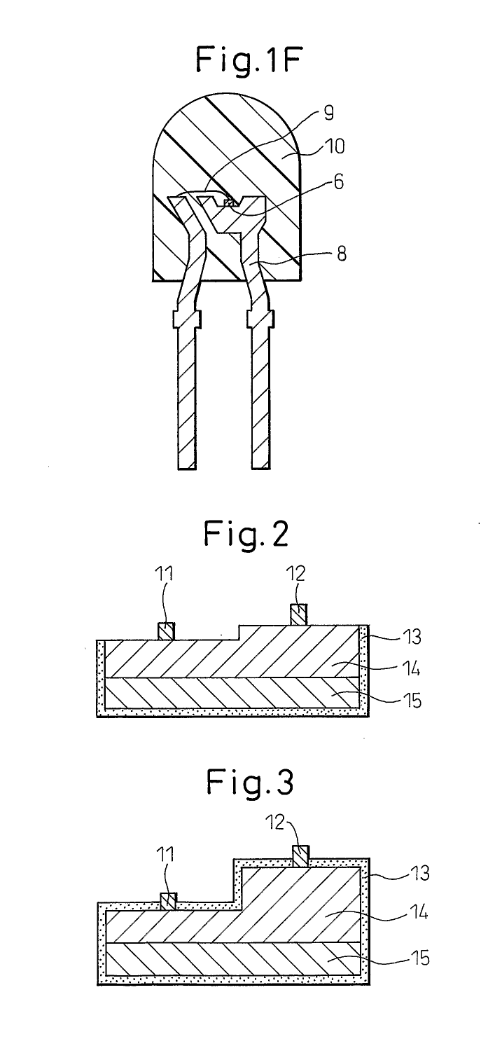

A general process of manufacturing the GaN-system LED is explained for reference (see FIG. 1A to FIG. 1F). In the following Examples, the manufacturing of the phosphor thin film is also explained with reference to manufacturing steps (1) to (9). A detailed manufacturing method is different depending on kinds of techniques, and the present invention is not limited to these steps.

(1) Prepare a sapphire wafer 5.

(2) Prepare various kinds of epitaxial thin-film layers 4 on the sapphire wafer 5 according to the MOCVD method.

(3) Apply a mask, and remove an unnecessary part a by etching.

(4) Prepare P and N electrodes 1 and 2 by sputtering or by deposition.

(5) Apply a tape 7 to one sapphire surface.

(6) Disconnect or disconnect by half the sapphire in a size of each LED chip 6 (a disconnection surface b).

(7) Check electric properties of each LED chip 6, and select and divide the LED chips by grade.

(8) Mount the LED chip 6 onto an electrode base (stem) 8, and fit wires 9 and 9′.

(9) Seal an exposed part of the LED chip 6 with a resin 10.

In the above process, it is preferable to insert a process of manufacturing a thin film of a phosphor material within a range of temperature at which an ultimate temperature of the wafer does not change the physical properties of the phosphor material. It is efficient to insert this manufacturing process into between steps (1) to (6), but the phosphor thin film may be added in the aggregated state of chips.

In the case of the GaN-system LED, a flip-chip type LED of extracting light from the sapphire surface, with this sapphire surface facing upward, has high efficiency of extracting light. Based on this method, a light-emitting diode can be manufactured more advantageously.

When the light emission surface is both the substrate and the epitaxial thin-film layer, the method of manufacturing the phosphor thin film for wavelength conversion in the state of the LED wafer or the state of the aggregated chips proposed by the present invention has a large effect.

In order to further increase the efficiency of light extraction, it is preferable that a phosphor film is formed on the whole surfaces of light extraction, thereby converting the wavelength of as much light as possible with the phosphor film. However, in general, the phosphor layer is an insulation film in many cases. Therefore, the presence of the phosphor thin-film layer has the risk of inability of not allowing to take conductivity with the electrodes.

While the LED that has no electrodes on the light extracting surface has no problem, the LED that has electrodes on the light extraction surface has a large problem. In order to further increase the efficiency of extracting light, light is extracted from the whole light emission surfaces that have possibility of extracting light. In this respect, it is preferable to establish a method of fitting a phosphor film on the whole surfaces excluding electrodes.

In order to remove a phosphor film from only the part where electrodes are present and to provide a phosphor thin-film layer as an insulator in general on other light extracting surfaces, the present invention provides the following method.

In other words, the present invention provides the method of manufacturing a light-emitting diode that comprises a step of forming a thin film mainly made of a phosphor material on a light extracting surface of the LED in the state of an LED wafer or aggregated chips, and a step of preventing interference of a conduction at an electrode part due to insulation of the phosphor thin-film layer, by masking or etching a part of the phosphor thin-film layer or by combining masking and etching.

The above method is explained in further detail as follows.

The method of manufacturing the LED as a primary light emission source is divided into a method of forming electrodes on the same surface and a method of forming electrodes on a different surface.

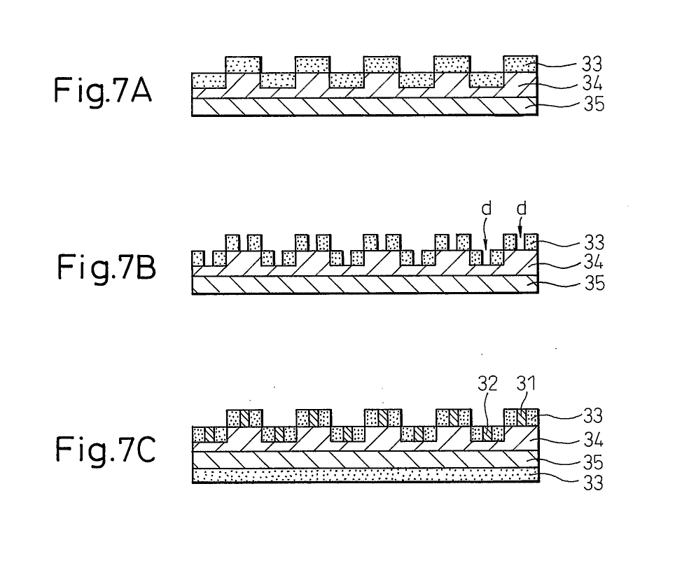

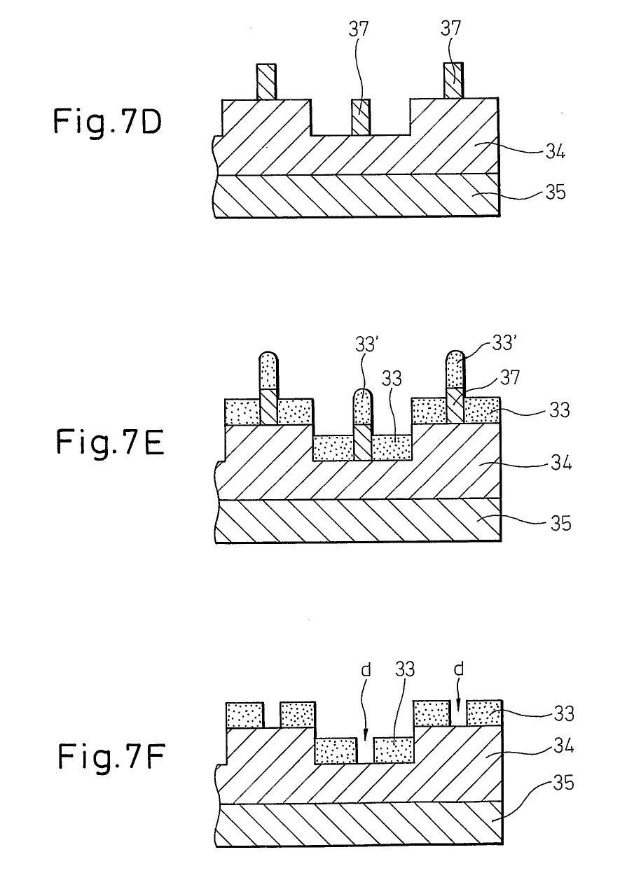

The method of forming electrodes on the same surface is fitting electrodes 31 and 32 on the same surface of an epitaxial thin-film layer 34, as shown in FIGS. 7A to 7C. Parts d of the epitaxial thin-film layer are etched, thereby removing the parts of the upper layer of the epitaxial thin-film layer 34 and exposing the lower layer. Then, the P and N electrodes 31 and 32 are fitted thereto.

Because the phosphor layer has insulation in many cases, conduction is secured in only a part where conduction of the electrodes is necessary, and other parts need to be covered with the phosphor thin-film layer 33.

In order to achieve this, according to the present invention, a light-emitting diode is manufactured by masking or etching or by both masking and etching a part of the phosphor thin-film layer 33 that becomes the interference, thereby securing conductivity of the electrodes. The part other than the electrodes is the phosphor thin-film layer.

A representative method of manufacturing the light-emitting diode by masking or etching a part of the phosphor thin-film layer that becomes the interference thereby securing conductivity of the electrodes according to the present invention is explained below (see FIG. 7A to FIG. 7F).

This method can be combined with various other methods, and a detailed method is different depending on types of techniques. Therefore, the present invention is not limited to the following method.

(1) The phosphor thin-film layer 33 is formed on the top of the ultimate epitaxial thin-film layer 34 (FIG. 7A). A part of the phosphor thin-film layer 33 on the epitaxial thin-film layer 34 or a part of both the phosphor thin-film layer 33 and the epitaxial thin-film layer 34 is etched (FIG. 7B) to remove the epitaxial thin-film layer 34 necessary for the fitting of the P and N electrodes, and the electrodes 31 and 32 are fitted to this layer (FIG. 7C).

(2) At the time of fitting the phosphor thin-film layer 33, the epitaxial thin-film layer 34 necessary for the fitting of the P and/or the N electrodes is masked 37, and the rest of the epitaxial thin-film layer 34 is removed (FIG. 7D). Then, the phosphor thin-film layer 33 is formed on this layer (FIG. 7E). Thereafter, a phosphor thin-film layer 33′ or the masking 37 of the phosphor thin-film layer and the epitaxial thin-film layer necessary for the fitting of the P and/or N electrodes 31 and 32 is removed (FIG. 7F). The epitaxial thin-film layer 34 necessary for the fitting of the P and/or N electrodes is removed, and the electrodes 31 and 32 are fitted to this layer (FIG. 7C).

Based on the present invention, chips having the phosphor thin-film layer excluding the electrode part can be mass produced at low cost. Further, a light-emitting diode having little irregular color, and this application product can be manufactured.

The phosphor thin-film layer is fitted to the upper surface and the lower surface of the LED chip in the manner as described above. A method of efficiently fitting the phosphor thin-film layer to a side surface of the LED chip is not provided yet.

In general, the side surface of the LED chip is a few hundred microns, and there is no method of efficiently fitting the phosphor thin-film layer to this small surface.

The inventor of the present invention has found a method of solving the above problems as follows.

In other words, the present invention provides a method of manufacturing a light-emitting diode, where in the above method of manufacturing a light-emitting diode, at the time of fitting a thin film mainly made of a phosphor material to the light extracting surface of the LED, the phosphor thin film is formed on the side surface of the LED in a state that two or more LED chips are aggregated.

Because, in general, the side surface of the LED chip has a size of a few hundred microns, it is extremely inefficient to fit the phosphor thin-film layer to this small area by the conventional method of coating, spraying, or sputtering. Apparently, this fitting method is costly.

As a result of various investigations, the inventor of the present invention has found the following simple method to achieve the object.

A general manufacturing process of the GaN-system LED is as explained at steps (1) to (9). A detailed method is different depending on types of techniques, and the present invention is not limited to the following method.

At the above steps (1) to (9), the LED chips are separately disconnected at step (7). Therefore, before mounting the LED chip onto the electrode base (stem) and applying wires at step (8), the LED chips are superimposed with each other, preferably by a few dozens to tens of thousands, thereby forming an aggregate of LED chips in a square pole shape.

A phosphor thin film can be fitted to the side surface of the LED chips in this square pole shape relatively easily at low cost.

Because the side surface of the LED chips in this square pole shape is a cutting face of the LED chips, one of the four surfaces is aligned, and a phosphor thin-film layer is formed. Next, another surface is aligned, and a phosphor thin-film layer is formed. This work is repeated by four times easily.

It is of course possible to cut the LED chips and align the four cut faces, thereby forming the phosphor thin-film layers on the four surfaces at one time.

According to the present invention, chips having the phosphor thin-film layer can be mass produced at low cost, for the flip-chip type LED, the face-up type LED, and the side surface of the LED. Further, a light-emitting diode having little irregular color, and this application product can be manufactured.

### EXAMPLES

### Example 1

FIG. 2 is a cross-sectional diagram of a light-emitting diode (LED) having a GaN system epitaxial layer 14 formed on a sapphire substrate 15 and having electrodes 11 and 12 formed on the same surface. A phosphor thin film 13 was applied to the surface of the sapphire substrate 15 and to a light-emitting surface of a side surface of the LED. This phosphor thin film mainly comprised a phosphor, and was manufactured by mixing YAG:Ce phosphor having a particle size of 4 microns and a binder (a mixture of Tetra Methoxy Methyl Silane (TMMS) and an aqueous 6% Acetic Acid solution) to form a slurry, coating the slurry and heating to 150° C. to form a thin film at a thickness of 20 microns. The obtained thin film contained the phosphor in an amount of 90% by weight based on the thin film.

As a result, a low-cost and highly efficient light-emitting diode having no irregular color and capable of converting a wavelength was obtained.

### Example 2

FIG. 3 is a cross-sectional diagram of a light-emitting diode having the GaN system epitaxial layer 14 formed on the sapphire substrate 15 and having the electrodes 11 and 12 formed on the same surface. The phosphor thin film 13 was applied to an electrode taking-out surface, in addition to the surface of the sapphire substrate 15 and to the light-emitting surface of the side surface of the DEL.

As a result, as compared with the light-emitting diode according to the Example 1, a lower-cost and more highly efficient light-emitting diode having no irregular color and capable of converting a wavelength was obtained.

### Example 3

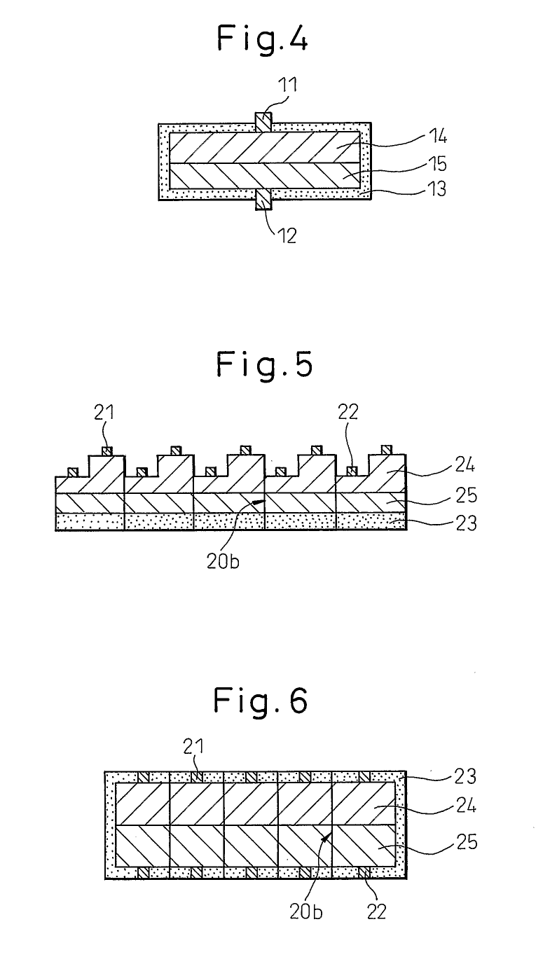

FIG. 4 is a cross-sectional diagram of a light-emitting diode having the GaN system epitaxial layer 14 formed on an SiC substrate 15. The phosphor thin film 13 was applied to the upper and lower surfaces and a side surface of the LED having the electrodes 11 and 12 formed on the upper and lower surfaces of the LED.

### Example 4

The method according to the present invention was applied to the process of manufacturing a GaN system light-emitting diode using a sapphire substrate.

Referring to FIG. 5, an epitaxial thin-film layer 24 was formed according to the MOCVD method at step (2), following general steps (1) to (9) of manufacturing a GaN system LED on a sapphire substrate 25 described before. A mask was applied, and an unnecessary part was removed by etching at step (3). A phosphor thin-film layer 23 was formed on the surface of the sapphire wafer substrate 25. P and N electrodes 21 and 22 were prepared by sputtering or by deposition at step (4).

The subsequent operation was carried out in the same manner as described before. As a result, production efficiency was improved substantially. Further, a light-emitting diode with little irregular color could be produced.

### Example 5

The method according to the present invention was applied to the process of manufacturing a GaN system light-emitting diode using a sapphire substrate.

P and N electrodes were formed by sputtering or by deposition at step (4) following general steps (1) to (9) of manufacturing a GaN system LED on a sapphire substrate described above. A phosphor thin-film layer was formed on the surface of the sapphire wafer substrate as shown in FIG. 1A to 1F. A tape was fitted at step (5) to the sapphire surface on which a phosphor thin-film layer was fitted.

The subsequent operation was carried out in the same manner as described before. A light-emitting diode obtained is shown in FIG. 5. A reference number 26 denotes a cutting plane.

As a result, production efficiency was improved substantially. Further, a light-emitting diode with little irregular color could be produced.

### Example 6

The method according to the present invention was applied to the process of manufacturing a GaN system light-emitting diode using an SiC substrate.

Referring to FIG. 6, in the case of manufacturing the SiC LED, there is no process of fitting a mask and removing an unnecessary part by etching at step (3). Therefore, at step (4), the P and N electrodes 21 and 22 were formed by sputtering or by deposition. The phosphor thin-film layer 23 was formed on the surface of the SiC substrate 25 and the epitaxial thin-film layer, as shown in FIG. 6. A reference numeral 26 denotes a cutting plane.

The subsequent operation was carried out in the same manner as the above.

As a result, production efficiency was improved substantially. Further, a light-emitting diode with little irregular color could be produced.

### Example 7

The method according to the present invention was applied to the process of forming the P and N electrodes 31 and 32 on the same surface of a GaN system light-emitting diode using a sapphire substrate 35 (see FIG. 7A to 7C).

The light-emitting diode was manufactured according to a general process of manufacturing the GaN system LED.

(a) An epitaxial thin-film layer 34 was formed according to the MOCVD method.

(b) A mask is applied, and an unnecessary part of the epitaxial thin-film layer 34 is removed.

(c) A phosphor thin-film layer 33 is formed on the sapphire wafer substrate 35.

(d) The phosphor thin-film layer 33 is formed on the whole surface of the epitaxial thin-film layer 34 formed at step (2).

(e) A phosphor thin-film layer of electrode parts, that is, the phosphor thin-film layer on the epitaxial thin-film layer necessary for the P and N electrodes, is removed by etching, thereby removing the epitaxial thin-film layer at only the part necessary for the P and N electrodes. Then, the electrodes 31 and 32 are fitted.

(f) The P and N electrodes at step (4) are prepared by sputtering or by deposition.

(g) The subsequent operation is carried out in the same manner as that at step (5) afterward. In FIG. 7A to FIG. 7C, reference numerals 31 and 32 denote electrodes, 33 denotes a phosphor layer, 34 denotes an epitaxial layer, 35 denotes a substrate, and 36 denotes a cutting plane.

Based on the manufacturing method according to the present Example, production efficiency was improved substantially. Further, a light-emitting diode with little irregular color could be produced.

### Example 8

The method according to the present invention was applied to the process of forming electrodes on the same surface of a GaN system light-emitting diode using the sapphire substrate 35 (see FIG. 7C to 7F).

The light-emitting diode was manufactured according to a general process of manufacturing the GaN system LED.

(a) An epitaxial thin-film layer 34 is formed according to the MOCVD method.

(b) A mask is applied, and an unnecessary part of the epitaxial thin-film layer 34 is removed.

(c) A phosphor thin-film layer 33 is formed on the sapphire wafer substrate 35.

(d) The phosphor thin-film layer 33 is formed by masking 37 the whole electrode extracting part of the epitaxial thin-film layer 34 formed at step (2).

(e) The phosphor thin-film layer is removed at only the masked part 37, thereby removing the epitaxial thin-film layer 33′ at the part necessary for the P and N electrodes.

(f) The P and N electrodes at step (4) are prepared by sputtering or by deposition.

(g) The subsequent operation is carried out in the same manner as that at step (5) afterward. In FIG. 7A to FIG. 7C, reference numerals 31 and 32 denote electrodes, 33 denotes a phosphor layer, 34 denotes an epitaxial layer, 35 denotes a substrate, and 36 denotes a cutting plane.

Based on the manufacturing method according to the present Example, production efficiency was improved substantially. Further, a light-emitting diode with little irregular color could be produced.

### Example 9

The method according to the present invention was applied to the process of forming the electrodes 31 and 32 on a different surface of a GaN system light-emitting diode using the SiC substrate 35 (see FIG. 8).

The light-emitting diode was manufactured according to a general process of manufacturing a GaN system light-emitting diode using an SiC substrate.

(1) The phosphor thin-film layer 33 is formed on the epitaxial surface 34 of the SiC substrate 35.

(2) The phosphor thin-film layer 33 of electrode parts, that is, the phosphor thin-film layer on the epitaxial thin-film layer necessary for the P and N electrodes, is removed by etching, thereby removing the epitaxial thin-film layer necessary for the P and N electrodes.

(3) The P and N electrodes 31 and 32 are prepared by sputtering or by-deposition.

The subsequent operation was carried out in the same manner as that at step 5 afterward. In FIG. 8, reference numerals 31 and 32 denote electrodes, 33 denotes a phosphor layer, 34 denotes an epitaxial layer, 35 denotes a substrate, and 36 denotes a cutting plane.

Based on the manufacturing method according to the present Example, production efficiency was improved substantially. Further, a light-emitting diode with little irregular color could be produced.

### Example 10

The method according to the present invention was applied to the process of forming the electrodes 31 and 32 on a different surface of a GaN system light-emitting diode using the SiC substrate 35 (see FIG. 8).

The light-emitting diode was manufactured according to a general process of manufacturing a GaN system light-emitting diode using an SiC substrate.

(1) The phosphor thin-film layer 33 is formed by masking the electrode extracting part of the epitaxial thin-film layer 34 on the SiC substrate 35.

(2) The phosphor thin-film layer is removed at only the masked part, thereby removing the surface necessary for the P and N electrodes.

(3) The P and N electrodes 31 and 32 are prepared by sputtering or by deposition. (4) The subsequent operation is carried out in the same manner as that at step (5) afterward.

Based on the manufacturing method according to the present Example, production efficiency was improved substantially. Further, a light-emitting diode with little irregular color could be produced. In FIG. 8, reference numerals 31 and 32 denote electrodes, 33 denotes a phosphor layer, 34 denotes an epitaxial layer, 35 denotes a substrate, and 26 denotes a cutting plane.

### Example 11

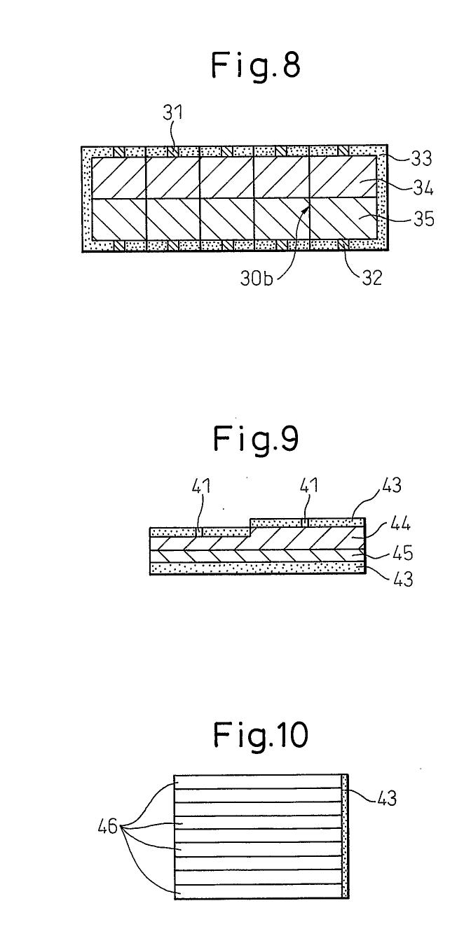

The method according to the present invention was applied to the process of forming P and N electrodes 41 and 42 on the same surface of a GaN system light-emitting diode using a sapphire substrate 45 (see FIG. 9).

(1) Prepare a sapphire wafer 45.

(2) Prepare various kinds of epitaxial thin-film layers 44 on the sapphire wafer 45 according to the MOCVD method.

(3) Apply a mask, and remove an unnecessary part by etching.

(4) Prepare P and N electrodes 41 and 42 by sputtering or by deposition.

(5) Apply a tape to a sapphire surface.

(6) Disconnect or disconnect by half the sapphire in a size of each LED chip.

(7) Check electric properties of each LED chip, and select and divide the LED chips by grade.

(8) Mount the LED chip onto an electrode base (stem), and fit wires.

(9) Seal an exposed part of the LED chip with a resin.

At the above step (7), the LED chips were disconnected. Therefore, before mounting the LED chip onto the electrode base (stem) and before applying wires in step (8), the LED chips 46 were superimposed, and a phosphor thin film 43 was formed on the side surface of the LED chips 16 as shown in FIG. 10.

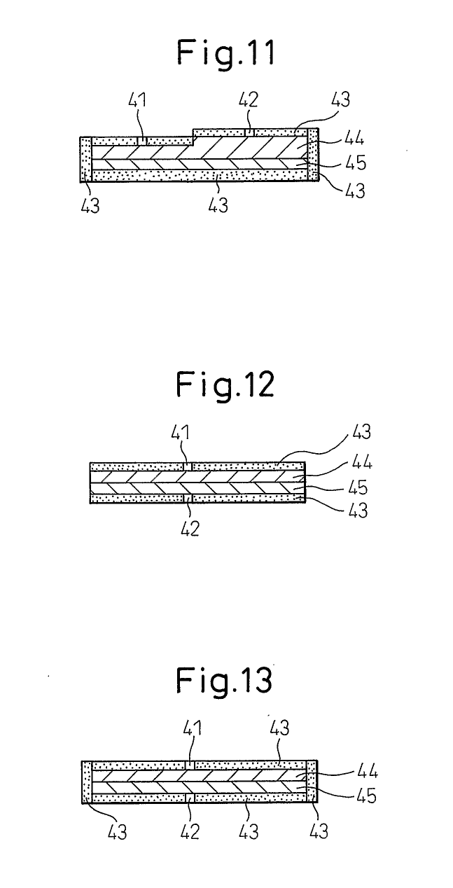

Based on the manufacturing method according to the present Example, the phosphor layer was formed neatly, including the side surface of the LED chips (FIG. 11).

In FIG. 9 to FIG. 11, reference numerals 41 and 42 denote electrodes, 43 denotes a phosphor layer, 44 denotes an epitaxial layer, 45 denotes a substrate, and 46 denotes LED chips.

### Example 12

The method according to the present invention was applied to the process of forming electrodes on a different surface of a GaN system light-emitting diode using an SiC substrate or a sapphire substrate (see FIG. 12).

In substantially the same manner as that of the method according to the Example 11, before the LED chips were disconnected and before the LED chip was mounted onto the electrode base (stem) and wires were applied, the LED chips were superimposed together, and a phosphor thin film was formed on the side surface of the LED chips.

Based on the manufacturing method according to the present Example, the phosphor layer was formed neatly, including the side surfaces of the LED chips (FIG. 13). In FIG. 12 and FIG. 13, reference numerals 41 and 42 denote electrodes, 43 denotes a phosphor layer, 44 denotes an epitaxial layer, and 45 denotes a substrate.

### INDUSTRIAL APPLICABILITY

According to the present invention, a low-cost and highly efficient light-emitting diode having no irregular color and capable of converting a wavelength can be formed.

1. A light-emitting diode comprising a GaN system LED (light-emitting diode) that emits light of a first light emission wavelength, and a phosphor material thin film that contains one or a few kinds of phosphor materials and converts light of the first light emission wavelength emitted from the LED into light of a second light emission wavelength, wherein the LED has a light extracting surface, and the phosphor material thin film is mainly made of a phosphor material.

2. The light-emitting diode according to claim 1, wherein the first light emission wavelength is shorter than the second light emission wavelength.

3. The light-emitting diode according to claim 1, wherein the LED is formed on a sapphire substrate or an SiC substrate.

4. The light-emitting diode according to claim 1, wherein a light emission color of the light-emitting diode is a white color.

5. The light-emitting diode according to claim 1, wherein the phosphor material thin film takes a 70% or more area of the light emission extracting surface of the LED.

6. The light-emitting diode according to claim 1, wherein the phosphor material thin film takes an 80% or more area of the light emission extracting surface of the LED.

7. The light-emitting diode according to claim 1, wherein the phosphor material thin film takes a 90% or more area of the light emission extracting surface of the LED.

8. The light-emitting diode according to claim 1, wherein the phosphor material thin film takes a 95% or more area of the light emission extracting surface of the LED.

9. The light-emitting diode according to claim 1, wherein the phosphor material thin film has a film thickness of 100 microns or less.

10. The light-emitting diode according to claim 1, wherein the phosphor material thin film has a film thickness of 50 microns or less.

11. The light-emitting diode according to claim 1, wherein the phosphor material thin film has a film thickness of 25 microns or less.

12. The light-emitting diode according to claim 1, wherein a weight percentage of the phosphor in the phosphor material thin film is 70% or more.

13. The light-emitting diode according to claim 1, wherein a weight percentage of the phosphor in the phosphor material thin film is 85% or more.

14. A method of manufacturing a light-emitting diode comprising a GaN system LED (light-emitting diode) that emits light of a first light emission wavelength, and a phosphor material thin film that contains a phosphor material and converts light of the first light emission wavelength emitted from the LED into light of a second light emission wavelength, the method comprising a step of forming the thin-film layer containing the phosphor material on a light extracting surface of the LED.

15. The method of manufacturing a light-emitting diode according to claim 14, wherein the thin-film layer contains a plurality of phosphor materials.

16. The method of manufacturing a light-emitting diode according to claim 14, the method comprising a step of forming a thin film mainly made of a phosphor material on the light extracting surface of the LED in a state of an LED wafer or aggregated chips.

17. The method of manufacturing a light-emitting diode according to claim 14, the method comprising:
a step of forming a thin film mainly made of a phosphor material on the light extracting surfaces of a plurality of LEDs in a state of an LED wafer or aggregated chips; and
a step of preventing interference of a conduction at an electrode part due to insulation of the phosphor thin-film layer, by masking or etching a part of the phosphor thin-film layer or by combining masking and etching.

18. The method of manufacturing a light-emitting diode according to claim 14, wherein in forming a thin film mainly made of a phosphor material on the light extracting surface of the LED, the phosphor thin film is formed on a side surface of LED chips in a state that two or more LED chips are aggregated.

19. The method of manufacturing a light-emitting diode according to claim 14, wherein a weight percentage of the phosphor in the phosphor material thin film is 70% or more.

20. The method of manufacturing a light-emitting diode according to claim 14, wherein a weight percentage of the phosphor in the phosphor material thin film is 85% or more.
